(19) United States
(12) Patent Application Publication
(10) Pub. No.: US 2006/0152922 A1
(43) Pub. Date: Jul. 13, 2006

(54) Cup

(76) Inventor: Cheng-Fu Lin, Taipei Hsien (TW)

Correspondence Address: BACON & THOMAS, PLLC, 625 SLATERS LANE, FOURTH FLOOR, ALEXANDRIA, VA, 22314, US

(21) Appl. No.: 11/033,266

(22) Filed: Jan. 12, 2005

(51) Int. Cl. F21V 33/00

(52) U.S. Cl. 362/154

(57) ABSTRACT

The present invention is to provide a cup comprising a cup body and a copy base. The cup base includes a circuit portion and a light emitting portion. The circuit portion controls the light emitting portion and provides the light emitting portion the power source needed, so as to project out light source from the light emitting portion. Therefore, the cup of the present invention can produce light source by employing the light emitting portion. In addition, since the cup body is detachably connected with the cup base, the cup is then able to be cleaned and transported more easily.

### FIELD OF THE INVENTION

The present invention relates to a cup, more particularly to a cup having a circuit portion for controlling a light emitting portion thereof and provides the light emitting portion the power source needed, so as to project out light source from the light emitting portion. Since the cup base is detachably connected with a cup body thereof, the cup is then able to be cleaned and transported more easily.

### BACKGROUND OF THE INVENTION

Conventionally, a cup comprises a containing space formed substantially at the central portion thereof for carrying objects or containing fluids (usually fluids) to achieve supporting or transportation purposes. In general, different cups have different kinds of outlooks, which are varied by colors, styles, decorations, patterns, and the material used.

However, when pouring a boiled fluid into a cup, the cup normally becomes very hot, which is unlikely to be held by bare hands. On the other hand, the outer surface of a cup may be wet in some occasions, which renders the outer surface slippery and difficult to hold. For these reasons, a holder is disposed at the two sides or the exterior of the cup. Furthermore, a cover is used and disposed on the opening of the cup for preventing dusts from entering into the cup, and for maintaining the temperature of the fluid in the cup.

However, the temperature of fluid is still not properly maintained by simply using the cover on the opening of the cup. Therefore, a cup made of different material is developed, so as to keep the temperature of the fluid in the cup. On the other hand, a cup having a inner portion and a outer portion is developed. The air between the inner portion and the outer portion is evacuated, leaving the gap in a vacuum state. Thus, the fluid contained in the containing space of the cup is insulated from the environment, thereby preventing the heat of the fluid from dissipating to the environment.

The cups that are used particularly for containing alcoholic drinks are made to have certain structure in accordance with the alcoholic drinks. For example, a beer cup comprises a holder for users to hold and raise the cup. The beer cup often has a wide opening and a large containing space for users thereof to enjoy huge gulps. However, cups for containing liquors often have a moderate opening size and an intermediate volume; while high heel cups have elongated cup bases for the ease of manipulation and preventing slippery.

However, if a cup is damaged or is stained, this cup will be discarded, which is rather wasteful and undesirable for the environment. Moreover, the color, style, decoration, pattern and material of a cup is normally fixed, which can not further enhance the visual effect when one is enjoying the alcoholic drink.

### SUMMARY OF THE INVENTION

In light of the above, a cup of the present invention is thus developed to solve the problems as set forth above.

It is an object of the present invention to provide a cup comprising a cup body and a copy base. The cup base includes a circuit portion and a light emitting portion. The circuit portion controls the light emitting portion and provides the light emitting portion the power source needed, so as to project out light source from the light emitting portion. Therefore, the cup of the present invention can produce light source by employing the light emitting portion. In addition, since cup body is detachably connected with the cup base, the cup of the present invention is then able to be cleaned and transported more easily.

The above and other objects, features and advantages of the present invention will become apparent from the following detailed description taken in conjunction with the accompanying drawings.

### BRIEF DESCRIPTION OF THE DRAWINGS

FIG. 1 is a perspective view of a cup in accordance with one embodiment of the present invention.

FIG. 2 is a perspective view of a cup in accordance with another embodiment of the present invention.

### DETAILED DESCRIPTION OF THE PREFERRED EMBODIMENTS

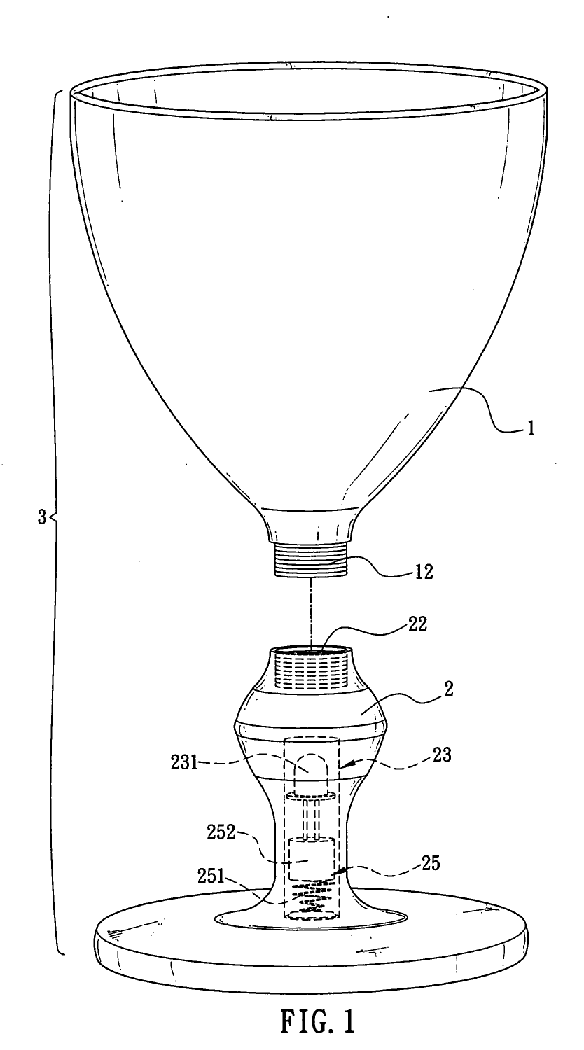

Referring to FIG. 1, a perspective view of a cup in accordance with one embodiment of the present invention is illustrated. The cup includes a cup body 1 and a cup base 2, wherein the cup body 1 is detachably connected with the cup base 2. The cup body 1 comprises a containing space disposed at one end thereof. The containing space is capable of containing substances, such as water and alcoholic drinks. The cup base 2 comprises a light emitting portion 23. The light emitting portion 23 projects light source outward. The light source interacts with the substance (usually alcoholic drinks) and the cup 3, thereby providing a decorative scene. The cup base 2 further comprises a circuit portion 24. The circuit portion is electrically connected to the light emitting portion 23. The circuit portion 24 provides power to the light emitting portion 23 and controls the operation of the light emitting portion 23. In this manner, the light source projected from the light emitting portion 23, the cup 3, and the substance contained in the cup can produce a distinctive visual effect, which distinguishes the cup 3 of the present invention from the conventional cups. In addition, since the cup body 1 and the cup base 2 are detachably connected, one can assemble and disassemble the cup 3 of the present invention for the convenience of transportation or cleaning.

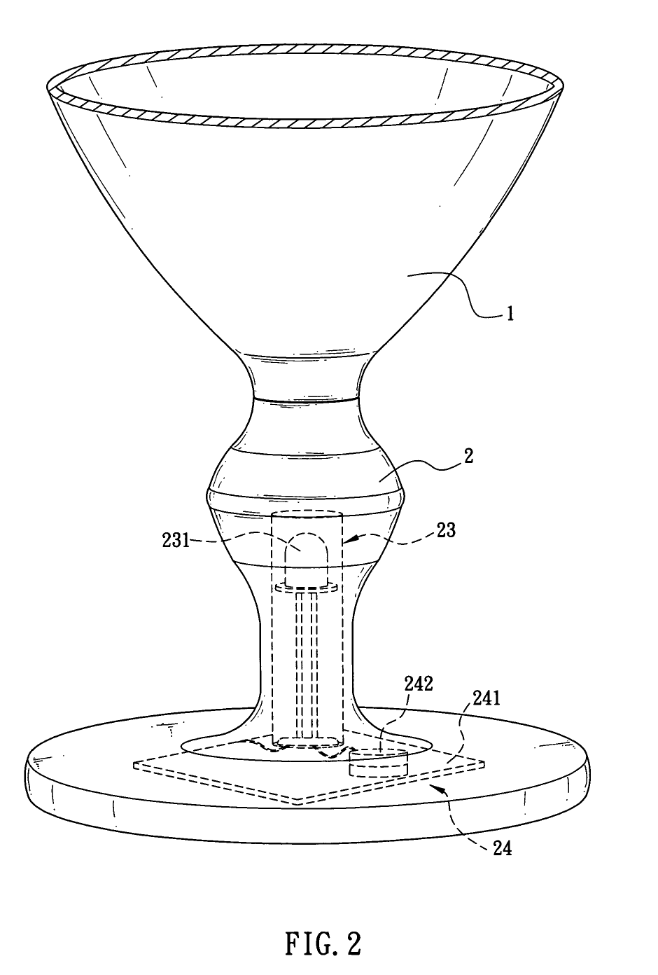

In accordance with another embodiment of the present invention, the cup body 1 comprises a first connection portion 12 at the other end thereof, while the cup base 2 comprises a second connection portion 22 at one end thereof. By connecting the second connection portion 22 with the first connection portion 21, the cup body 1 and the cup base 2 are combined together. Referring to FIG. 2, the circuit portion 24 further comprises a control circuit 241. The control circuit 241 comprises a plurality of electronic elements. The electronic elements can control the light emitting status of the light emitting portion 23. The circuit portion 24 further comprises a power supply 242. In this particular embodiment, the power supply 242 is a battery. The power supply 242 is electrically connected to the control circuit 241 for providing power to the control circuit 241, so as to provide power to the electronic elements and the light emitting portion 23, thereby projecting out light source from the light emitting portion 23.

In the particular embodiment set forth above, the employment of the power supply 242 will increase the size and weight of the cup 3. In addition, the esthetic value of the cup 3 will be reduced due to the presence of the circuit portion 24. Therefore, referring again to FIG. 1, the circuit portion 24 comprises an inductive circuit 25 according to another embodiment of the present invention. The inductive circuit 25 comprises an inductive coil 251 and at least a charging unit 252 (e.g. a capacitor). When the inductive circuit 25 receives an electromagnetic wave, the inductive coil 251 converts the electromagnetic wave into the power needed for the light emitting portion 23, and stores in the charging unit 252. The light emitting portion can thus obtain power from the charging unit as needed. In this manner, the esthetic value of the cup 3 is enhanced, while the detachable assembly and the light emitting function of the cup 3 are maintained.

In the particular embodiments mentioned above, the light emitting portion 23 comprises at least a light emitting element 231 (e.g. a light emitting diode). The light source generated from the light emitting element 231 is facing toward the cup 1, thereby producing a dazzling visual effect in the cup body 1, the substance contained in the cup body, and one part of the cup base. In addition, since the light source of the light emitting element 231 is projected to different directions, a distinctive visual effect is produced in the cup body. Furthermore, when the first connection portion 12 of the cup body 1 and the second connection portion 22 of the cup base 2 are detached, the cup body 1 and the cup base 2 can be cleaned independently to prevent damages. Moreover, when either the cup body 1 or the cup base 2 is damaged, the damaged part can be replaced individually without replacing the entire cup 3. Therefore, the cup 3 of the present invention is environmentally preferable. Last but not least, the separation of the cup body 1 and the cup base 2 can reduce the cost and the storage space in transportation.

While the invention has been described by means of specific embodiments, numerous modifications and variations could be made thereto by those skilled in the art without departing from the scope and spirit of the invention set forth in the claims.

What is claimed is:

1. A cup, comprising:
a cup body including a containing space formed at one end thereof for containing therein a substance;
a cup base, one end of the cup base being detachably connected with one end of the cup body;
a light emitting portion disposed in the cup base for projecting light source outward; and
a circuit portion, the circuit portion being disposed in the cup base and connected with the light emitting portion for providing a power source to the circuit portion and for controlling the light emitting status of the light emitting portion.

2. The cup as recited in claim 1, wherein the other end of the cup body comprises a first connection portion, and one end of the cup base comprises a second connection portion, the first connection portion and the second connection portion being connected with each other for assembling the cup body and the cup base.

3. The cup as recited in claim 1, wherein the circuit portion further comprises:
a control circuit, comprising a plurality of electronic elements, whereby the electronic elements are used to control the light emitting status of the light emitting portion; and
a power supply, the power supply being electrically connected with the control circuit, whereby the power supply provides power source to the control circuit, so as to provide power source to the electronic elements and the light emitting portion, thereby projecting out light source from the light emitting portion.

4. The cup as recited in claim 1, wherein the circuit portion comprises an inductive circuit, the inductive circuit comprising:
an inductive coil, the inductive coil receiving an electromagnetic wave and converting the electromagnetic wave into power source for the light emitting portion; and
at least a charging unit, the charging unit being electrically connected to the inductive circuit for storing the power source converted from the received electromagnetic wave and providing power source to the light emitting portion.

5. The cup as recited in claim 1, wherein the light emitting portion comprises a plurality of light emitting elements, the light emitting elements being facing toward the same direction.

6. The cup as recited in claim 1, wherein the light emitting portion comprises a plurality of light emitting elements, the light source from the light emitting elements projecting toward different directions.
